(19) United States
(12) Patent Application Publication
(10) Pub. No.: US 2006/0229892 A1
(43) Pub. Date: Oct. 12, 2006

(54) Efficient content production

(76) Inventor: Gregory A. Piccionelli, Westlake Village, CA (US)

Correspondence Address: Michael M. Gerardi, 28876 Woodcrest Lake Drive, Menifee, CA, 92584, US

(21) Appl. No.: 11/101,381

(22) Filed: Apr. 7, 2005

(51) Int. Cl. G06Q 99/00

(52) U.S. Cl. 705/1

(57) ABSTRACT

A method of producing content includes the steps of: transporting a plurality of customers to a facility for producing content, to which facility a plurality of performers are also transported; producing the content at a first site at the facility, the content including depictions of at least a first portion of the plurality of performers; and providing at least one liver performance for at least a portion of the plurality of customers at a second site at the facility, the at least one live performance being performed by at least a second portion of the plurality of performers, the second portion being distinct from the first portion.

### FIELD OF THE INVENTION

The present invention relates to methods and systems for the production of content, such as still images and video streams. More particularly, the present invention relates to methods and systems for production of content that minimize performer down time and avoid burdensome or hostile regulatory environments.

### BACKGROUND OF THE INVENTION

Production of photographs, recorded performances, live video streams and the like has become widespread and highly lucrative. This is particularly true with respect to the production of adult content. In certain jurisdictions, such as California, production of adult content comprises a significant segment of the local economy. In other jurisdictions, however, local laws and regulations are less favorable, or even hostile, to the production of adult content. And even in non-hostile jurisdictions such as California, production of adult (and other) content is often subject to onerous regulations, such as OSHA-type regulations.

Production of adult (and other) content is also subject to pricing pressure. Profit margins are often low on individual photographs and videos. Consequently, performers are often minimally compensated for their performances. Furthermore, performers depicted in the content frequently experience long periods of down time during which they are unable to perform (due to set construction, lighting changes, other technical factors, etc.), and thus unable to increase their performance income.

A need exists for a method and system for producing content, such as adult content, which avoids the need to operate within hostile, highly regulated and/or expensive jurisdictions.

A need also exists for a method and system for producing content which affords performers depicted in the content increased opportunities for compensated performance.

### SUMMARY OF THE PREFERRED EMBODIMENTS

In accordance with one aspect of the present invention, there is provided a method of producing content which includes the steps of: transporting a plurality of customers to a facility for producing content, to which facility a plurality of performers are also transported; producing the content at a first site at the facility, the content including depictions of at least a first portion of the plurality of performers; and providing at least one live performance for at least a portion of the plurality of customers at a second site at the facility, the at least one live performance being performed by at least a second portion of the plurality of performers, the second portion being distinct from the first portion.

In particular embodiments, the production and live performance are carried out substantially simultaneously, or at least overlap in time. Thus, one or more of the performers can participate in the production of content, while at the same or substantially the same time, some or all of the remaining performers can participate in a live performance for some or all of the customers.

The live performance can include, for example, a staged musical, theatrical or dance production in which some or all of the performers not involved in the production of content can participate and be compensated. In more particular embodiments, at least one of the performers can perform for an individual customer, for example, dance for an individual customer in a private or non-private area within the second site. In specific embodiments, the performer is compensated by the individual customer for the performance. In this way, performers not presently involved in the production of content can take advantage of the down time to perform for one or more customers, thus increasing their income.

Other particular embodiments of the live performance include participation by a performer and a customer in a game, such as a game of chance. In more specific embodiments, the customer is provided with a premium by the performer when the customer wins the game. Such premiums can include, in very specific embodiments, a dance performed by the performer, or physical contact (a hug, kiss, etc.) between the performer and the customer.

Customers can view the production of content as well as attend performances by performers not currently involved in content production according to additional specific embodiments. To permit customer viewing of content production, the first site includes viewing means enabling at least a portion of the plurality of customers to view the production of the content. The viewing means can include at least one window through which the customers are able to view the production of the content, in certain particular embodiments, or at least one monitor, in other particular embodiments. Customers can be charged a premium to view the production in additional embodiments.

In additional embodiments, content is produced at two or more sites, with one or more of the performers participating in production of the content at each site and the remaining performers performing for one or more customers as described above.

Content of various types can be produced according to methods of the invention. Exemplary embodiments include still images and video streams, the latter including video streams that are recorded for future sale and/or transmission over a network and video streams that are transmitted live over a network, such as a computer network (e.g., the Internet), a telecommunications network such as a cellular telephone network, and the like.

The facility used according to certain embodiments of the inventive method is a studio, typically a studio for the production of still photographs, films, videos, etc. According to other embodiments, the facility is a marine vessel equipped with means for producing content, and more particularly also equipped with accommodations for a plurality of passengers, including the plurality of performers and the plurality of customers. In such “cruise” embodiments, the customers and performers are transported aboard the marine vessel into international waters. After the marine vessel reaches international waters, the content is produced at a first site on board the marine vessel. At least one live performance is also provided for at least a portion of the plurality of customers at a second site on board the marine vessel.

In accordance with another aspect of the present invention, there is provided a system for producing content. The system includes a marine vessel, accommodations for a plurality of passengers, a first site on board the marine vessel for production of content, means located at the first site for producing content on board the marine vessel, and a second site on board the marine vessel for live performances.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is an illustration of a marine vessel including passenger accommodations, a site for production of content, and a separate site for live performances,

FIG. 2 is an illustration of production of content at the site provided, and

FIG. 3 is an illustration of a performance at the site provided, the performance taking place while the content is being produced.

Like numerals refer to like parts throughout the several views of the drawings.

### DETAILED DESCRIPTION OF THE PREFERRED EMBODIMENTS

As used herein, the term “content” includes any visual depiction of one or more persons, objects or locations, and includes still images (i.e., data files) and videos. The videos in turn can be recorded for subsequent sale and/or transmission (video streaming) or transmitted live over a network (live streaming). “Content” includes both the singular and the plural; thus, production of content encompasses production of one or more visual depictions, from a single still image to multiple videos. “Adult content” encompasses visual depictions of adult subject matter, both non-explicit and explicit, and includes depictions of non-explicit and explicit sexual activity.

A “network” includes, but is not limited to, a computer network, whether hard-wired or telephone-based, including wide-area networks such as the Internet; telecommunications networks, including satellite networks, ground lines and microwave transmission systems; cellular telephone networks; and the like.

A “marine vessel” includes any seaworthy vessel capable of navigation in international waters, i.e., those waters beyond the territorial waters of any nation or territory. Cruise ships, yachts, cargo ships and the like are non-limiting examples of marine vessels for the purposes of the invention.

Production of content according to methods of the invention meets the long-felt need to avoid violations of local laws that may inhibit or prohibit production of adult content for hire (e.g., local pimping, pandering and/or prostitution laws), as well as burdensome state and local regulations such as OSHA laws. Methods of the invention afford the further advantage of enabling performers in content to take advantage of down time between shoots by performing for other passengers aboard the marine vessel, and thus increase their income. Customers are also provided with an entertaining environment in an attractive setting, which may command a premium price and thus provide additional profit potential for the operators of the marine vessel.

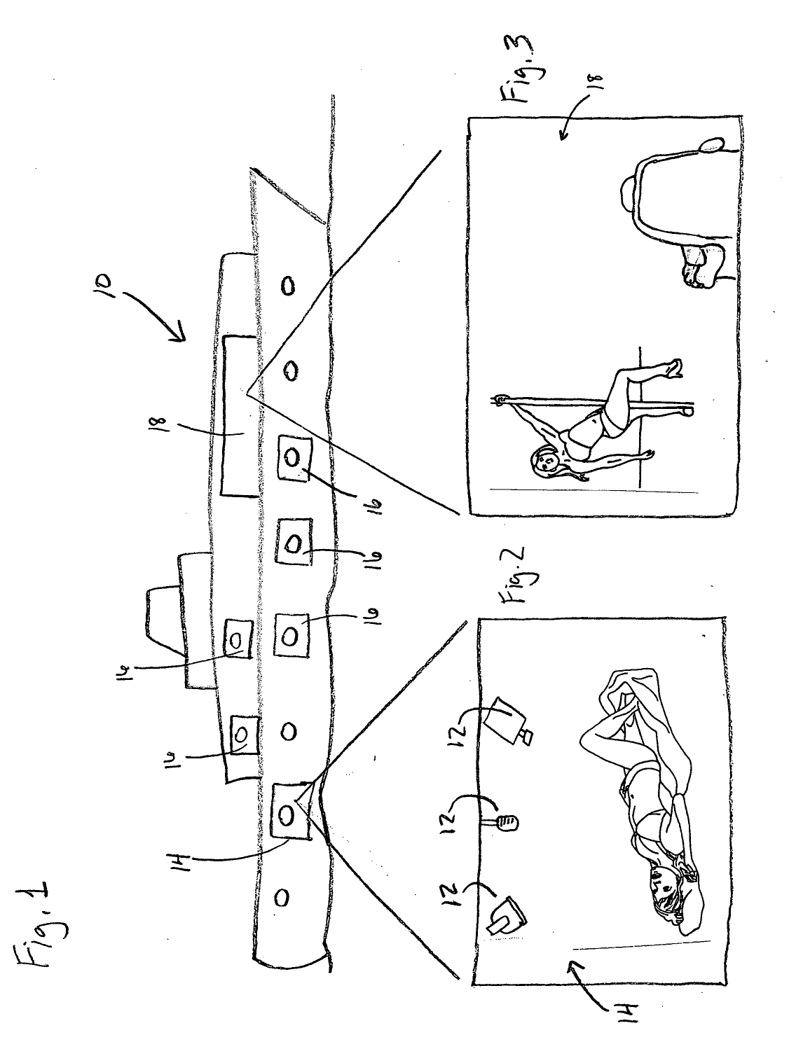

Turning now to the drawings, FIG. 1 illustrates a first particular embodiment of a method according to the invention. A marine vessel 10 includes means 12 for producing content, which are located in first site 14 on board the vessel. Means 12 can include, in particular embodiments, one or more cameras, one or more lighting systems, one or more microphones, and one or more recording devices. More specific embodiments of means 12 can include the systems disclosed and claimed in copending U.S. patent application Ser. No. 10/822,212, to Piccionelli, filed Apr. 9, 2004 and incorporated herein in its entirety by reference. First site 14 can be a stateroom or cabin reserved for the purpose of producing content, a multipurpose room such as a meeting room reserved for the same purpose, or a permanent production facility within the marine vessel.

The content produced at first site 14 can include still images such as digital photography or traditional photography; video or film recordings, which can be recorded for subsequent transmission and/or sale or transmitted live over a network; audio recordings; or any combination thereof. Multiple content can be produced at first site 14 either sequentially or simultaneously. Alternatively, marine vessel 10 can include a plurality of sites for the production of content, and content can be produced at some or all of the sites simultaneously, sequentially or according to any other desired schedule. Performers can participate in the production of content at one or more of these sites according to any desired schedule.

Marine vessel 10 further includes a plurality of accommodations 16 for passengers (such as staterooms, suites and the like), and second site 18 for live performances. Second site 18 can be a multipurpose room such as a meeting room, or alternatively a facility such as a nightclub, dance hall or theater permanently located within the marine vessel.

In carrying out embodiments of the foregoing method according to the invention, a plurality of passengers, including a plurality of performers and a plurality of customers, embark upon the marine vessel, which then proceeds from port into international waters. Once in international waters, one or more performers participate in the production of content at first site 14 (see FIG. 2), while other performers not participating in the production of content at first site 14 perform for one or more customers at second site 18. Some or all of the performers who board the marine vessel can participate in the live performance, which can be any desired type of performance.

Non-limiting performances include dramatic, theatrical, musical and dance performances. According to more particular embodiments, one or more performers can perform for, and in specific embodiments be compensated by, individual customers. Such performances can include, without limitation, exotic dancing (see FIG. 3), lap dancing, or other forms of dancing such as ballroom dancing, as well as singing, performing magic tricks, etc.

Additional performances can include participation by a performer and a customer in a game, such as a game of chance. When the customer wins, a premium can be provided to the customer. Such premiums can include, without limitation, a monetary prize, an award such as a trophy or other tangible good, a coupon redeemable for a good or service, a dance or other performance by the performer, or a kiss, hug, or other physical contact between the performer and the customer.

As well as viewing live performances by one or more performers at second site 18, customers are enabled, in further particular embodiments, to view content produced at first site 14, optionally upon payment of a premium. Customers can view the content, for example, through one or more windows in first site 14, in staterooms over a dedicated on-board network such as a closed-circuit TV network, or by purchase of recordings of the content made on board the marine vessel, such as video tapes, DVD's and the like, and subsequent viewing of the recordings in staterooms or other rooms provided with tape or DVD players. Such embodiments of methods according to the invention afford additional opportunities for profit to the marine vessel owners, content producers and performers.

More general embodiments of methods according to the invention can be carried out in locations other than on marine vessels. In particular, embodiments of the inventive method can be practiced at any facility for the production of content. Such facilities include, without limitation, studios for the production of still photographs, films, videos and the like; homes, hotel or motel rooms, and mobile facilities for the production of content, such as portable structures and vehicles equipped with cameras, lighting systems and/or sound systems; and the like. Systems such as those described and claimed in U.S. patent application Ser. No. 10/822,212 are particularly useful in practicing such embodiments of the inventive method.

In such methods, rather than transporting both customers and performers to a site outside the boundaries of a nation (e.g., into international waters), a plurality of customers are transported to the facility, at which a plurality of performers are present (or to which a plurality of performers are subsequently transported). In such “studio tour” embodiments, once the customers are present at the facility, a first portion of the plurality of performers can participate in the production of content, while a second portion of the plurality of performers can perform for customers, as described previously. Customers can also observe the production of content, again as described previously, typically by means of windows and/or monitors.

What is claimed is:

1. A method of producing content comprising the steps of:
a) transporting a plurality of customers to a facility for producing content, to which facility a plurality of performers are also transported,
b) producing the content at a first site at the facility, the content including depictions of at least a first portion of the plurality of performers, and
c) providing at least one live performance for at least a portion of the plurality of customers at a second site at the facility, the at least one live performance being performed by at least a second portion of the plurality of performers, the second portion being distinct from the first portion.

2. The method of claim 1 wherein steps b) and c) are carried out substantially simultaneously.

3. The method of claim 1 wherein in step c) at least one of the performers performs for an individual customer.

4. The method of claim 1 wherein in step c) each of the second portion of the plurality of performers is compensated for performing.

5. The method of claim 3 wherein the individual customer compensates the performer for performing.

6. The method of claim 1 wherein the content is selected from the group consisting of a still image and a video stream.

7. The method of claim 6 wherein the video stream is recorded.

8. The method of claim 7 wherein the recorded video stream is transmitted over a network.

9. The method of claim 6 wherein the video stream is transmitted live over a network.

10. The method of claim 1 wherein in step c) the performance is a dance.

11. The method of claim 1 wherein in step c) the performance comprises participation by a performer and a customer in a game.

12. The method of claim 11 wherein the game is a game of chance.

13. The method of claim 11 wherein the customer is provided with a premium by the performer when the customer wins the game.

14. The method of claim 13 wherein the premium comprises a dance performed by the performer.

15. The method of claim 13 wherein the premium comprises physical contact between the performer and the customer.

16. The method of claim 1 wherein in step b) at least a portion of the plurality of customers view the production of the content and the first site comprises viewing means enabling at least a portion of the plurality of customers to view the production of the content.

17. The method of claim 16 wherein the viewing means comprise at least one window through which the customers are able to view the production of the content.

18. The method of claim 16 wherein the viewing means comprise at least one monitor.

19. The method of claim 16 wherein the customers are charged a premium in order to view the production of the content.

20. The method of claim 1 wherein the facility is a studio.

21. The method of claim 1 wherein step a) comprises providing a marine vessel equipped with means for producing content and accommodations for a plurality of passengers and transporting a plurality of passengers on the marine vessel into international waters, the plurality of passengers comprising the plurality of performers and the plurality of customers.

22. The method of claim 21 wherein step b) comprises producing the content at a first site on board the marine vessel.

23. The method of claim 21 wherein step c) comprises providing at least one live performance for at least a portion of the plurality of customers at a second site on board the marine vessel.

24. A method of producing content comprising the steps of:
a) providing a marine vessel equipped with means for producing content and accommodations for a plurality of passengers,
b) transporting a plurality of passengers on the marine vessel into international waters, the plurality of passengers comprising a plurality of performers and a plurality of customers,
c) producing the content at a first site on board the marine vessel, the content including depictions of at least a first portion of the plurality of performers, and
d) providing at least one live performance for at least a portion of the plurality of customers at a second site on board the marine vessel, the at least one live performance being performed by at least a second portion of the plurality of performers, the second portion being distinct from the first portion.

25. A system for producing content, the system comprising a marine vessel, accommodations for a plurality of passengers, a first site on board the marine vessel for production of content, means located at the first site for producing content on board the marine vessel, and a second site on board the marine vessel for live performances.
